(19) United States
(12) Patent Application Publication
(10) Pub. No.: US 2017/0327060 A1
(43) Pub. Date: Nov. 16, 2017

(54) WIRE HARNESS

(71) Applicant: SUMITOMO WIRING SYSTEMS, LTD., Mie (JP)

(72) Inventor: Hiromichi NAKAJIMA, Mie (JP)

(73) Assignee: SUMITOMO WIRING SYSTEMS, LTD., Mie (JP)

(21) Appl. No.: 15/531,195

(22) PCT Filed: Dec. 9, 2015
(86) PCT No.: PCT/JP2015/084507

§ 371 Date: May 26, 2017

(30) Foreign Application Priority Data
Dec. 16, 2014 (JP) 2014-254208

(51) Int. Cl. B60R 16/02; H01B 7/08

(52) U.S. Cl. CPC B60R 16/0215; H01B 7/0823

(57) ABSTRACT

A wire harness includes a plurality of outer cover materials covering a plurality of outer coverage zones spaced in a lengthwise direction of a main line portion of a wire bundle, the plurality of outer cover materials being formed into a plate shape from their respective nonwoven material and being a plurality of plate-shaped bodies having a plate width in the lengthwise direction of the main line portion and a plate length greater than the plate width in a radial direction of the main line portion.

### FIELD OF THE INVENTION

The present invention relates to a wire harness, and in particular a wire harness equipped with an outer cover material formed from a lightweight and flexible material such as a nonwoven fabric and the like.

### BACKGROUND OF THE INVENTION

In wire harnesses mounted in vehicles such as automobiles and the like, outer cover materials are often attached to specific zones in a lengthwise direction of a group of wires for the purpose of wire protection and the like. Conventionally, outer coverage materials formed as porous fiber aggregates from nonwoven materials are known to be used to reduce product variation in an outer shape and to enhance protective functions and sound insulation.

In this type of wire harness, an outer cover material is known, for example, in which an easily-bendable straight line portion is provided in a hot-pressed and plate-shaped nonwoven member, and the plate-shaped nonwoven member is folded or bent so as to cover electric wires and form an outer cover material running along a wire bundle, thereby reducing product variation in the outer shape (see, for example, Patent Literature 1).

In addition, an outer cover material is known in which a first portion covering a portion of an outer periphery of the wire bundle and a second portion more flexible than the first portion are provided, thereby achieving a wire bundle path regulating function and a noise suppressing function (see, for example, Patent Literature 2).

### RELATED ART

### Patent Literature

Patent Literature 1: Japanese Patent Laid-open Publication No. 2013-188043

Patent Literature 2: Japanese Patent Laid-open Publication No. 2013-175382

### SUMMARY OF THE INVENTION

### Problems to Be Solved by the Invention

However, with the conventional wire harnesses described above, while it was possible for the outer cover materials to have multiple functions, the outer cover materials did not have good assembly workability or installation workability for installing a covered wire harness in vehicles and the like.

In addition, for each routing pattern, which differs depending upon the specifications of the wire harness, a dedicated assembly drawing board with jigs was used in which the corresponding wiring pattern was drawn on a plate surface thereof; thus, manufacturing cost of a wire harness was high due to reasons such as low recyclability of the assembly drawing board and the like.

Furthermore, since the outer cover materials were in a tube-shaped outer covering (cover) form, the outer covering form did not have a high degree of wiring freedom such that it might contribute to optimization of routing patterns of the wire harness or reduction of wire length.

The present invention was conceived to solve these conventional problems, and the purpose thereof is to provide a low-cost wire harness having an outer cover form having good assembly workability and installation workability for installing in vehicles and the like after coverage, and enables reduction of wire length.

### Means for Solving the Problems

In order to achieve the purpose set forth above, an electric wire protector according to the present invention is a wire harness having a plurality of outer cover materials covering a plurality of outer coverage zones spaced in a lengthwise direction of a main line portion of a wire bundle. The plurality of outer cover materials are respectively formed into a plate shape from a porous flexible material, and are a plurality of plate-shaped bodies having a plate width in the lengthwise direction of the main line portion and a plate length greater than the plate width in a radial direction of the main line portion.

Therefore, in the present invention, each of the plate-shaped bodies that form the outer cover materials covers the corresponding outer coverage zone of the wire harness, and at the same time, the wire harness can be held in an arbitrary partial wiring shape. Thus, it is possible to commonly use the outer cover materials with respect to various routing patterns when installing wire harnesses, and at the same time, the wire harness can be easily manufactured into a product form close to the routing pattern thereof by using the plurality of outer cover materials. Moreover, it is possible to fold the covered wire harness so that the plurality of outer cover materials overlap, thereby making the product form compact and simple, and just by unfolding the wire harness, the product form thereof can be made into a form close to a required routing pattern. Therefore, the wire harness has excellent installation workability whereby the number of steps for installing the wire harness in a vehicle and the like can be greatly reduced.

In the wire harness of the present invention, it is preferable that each of the plurality of plate-shaped bodies is configured by a first-side nonwoven fabric plate and a second-side nonwoven fabric plate which face each other with the wire bundle therebetween and are partially joined.

According to this configuration, the wire harness is sandwiched at each outer coverage zone by the first-side nonwoven fabric plate and the second-side nonwoven fabric plate of a corresponding outer cover material, and by utilizing the protective functions and sound-insulating features and the like of both nonwoven fabric plates, the number of other outer cover materials used for protection and sound insulation and the like can be reduced.

In the wire harness of the present invention, a plurality of through hole portions penetrating in a plate thickness direction are formed at an equal pitch in each of the plurality of plate-shaped bodies.

This way, by utilizing the through hole portions, it is possible to position the first-side and the second-side nonwoven fabric plates of the plurality of plate-shaped bodies using positioning pins erected on a wire harness assembly work table (including positioning upon overlapping), and to insert through the through hole portions support columns of a plurality of work jigs erected on the work table along the routing pattern of the wire harness. Thereby, assembly work of the wire harness is made easier. Moreover, since erection positions of the jigs are set at a pitch unit of the through hole portions, the same work table can be utilized to assemble a variety of wire harnesses. Thus, the manufacturing cost of the wire harness can be reduced from such aspect as well.

In the wire harness of the present invention, the first-side nonwoven fabric plates and the second-side nonwoven fabric plate are preferably partially heat welded.

In this case, in a case where the nonwoven fabric material contains binder components or is formed of a weldable material, by heat pressing the first-side nonwoven fabric plates and the second-side nonwoven fabric plates under high heat and high pressure and heat welding them, it is possible to achieve stable bonding of both nonwoven fabric plates without the use of adhesives or other bonding method.

### Effect of the Invention

According to the present invention, it is possible to provide a low-cost wire harness having an outer cover form having good assembly workability and installation workability for installing in vehicles and the like after coverage, and enables reduction of wire length.

### BRIEF DESCRIPTION OF THE DRAWINGS

FIG. 1 is an external perspective view of a wire harness according to one embodiment of the present invention.

FIG. 2 is a perspective view of a state where a plurality of outer cover materials of the wire harness according to the embodiment of the present invention are folded so as to overlap with one another.

FIG. 3A illustrates, in explaining a molding process of a nonwoven fabric plate configuring the outer cover material of the wire harness according to the embodiment of the present invention, a stage where a nonwoven material is molded into a plate shape by heat-molding.

FIG. 3B illustrates, in explaining the molding process of the nonwoven fabric plate configuring the outer cover material of the wire harness according to the embodiment of the present invention, a stage where burr around a molded article is removed and a plurality of through hole portions are bored at an equal pitch to produce a nonwoven plate.

FIG. 4 is an explanatory diagram of a first outer cover process stage where, using an equally pitched porous metal plate as a common work table and after arranging on the work table a plurality of assembly jigs corresponding to a routing pattern of the wire harness according to the embodiment of the present invention, first-side nonwoven fabric plates of each of the plurality of outer cover materials of the wire harness according to the embodiment of the present invention are arranged on the work table.

FIG. 5 is an explanatory diagram of a second cover process stage where an uncovered semi-finished wire harness product is arranged on top of the plurality of first-side nonwoven fabric plates illustrated in FIG. 4 and along a wiring pattern of the wire harness.

FIG. 6 is an explanatory diagram of a third cover process stage where second-side nonwoven fabric plates of each of the plurality of outer cover materials are arranged so as to overlap the plurality of first-side nonwoven fabric plates and the uncovered semi-finished wire harness product illustrated in FIG. 5.

FIG. 7 is an explanatory diagram of a fourth cover process stage where the plurality of first-side nonwoven fabric plates and the plurality of second-side nonwoven fabric plates illustrated in FIG. 6 are partially joined with each other at multiple points avoiding the semi-finished wire harness product illustrated in FIG. 6, and both nonwoven fabric plates are bonded together.

### MODE FOR CARRYING OUT THE INVENTION

Hereinafter, embodiments for carrying out the present invention will be described with reference to the drawings.

(Embodiment)

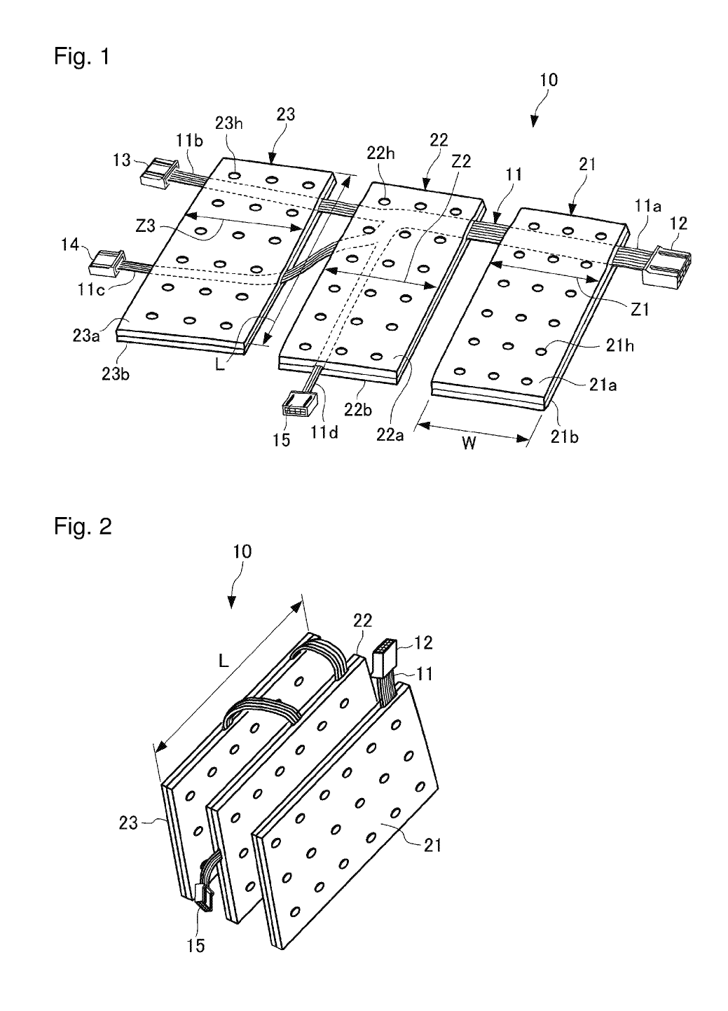

FIGS. 1 and 2 illustrate a wire harness according to one embodiment of the present invention.

As illustrated in FIGS. 1 and 2, a wire harness 10 according to the present embodiment is a wire harness to be mounted on a floor surface side of a vehicle cabin of an automobile and is equipped with a group of wires in a bundled form configured by a plurality of electric wires, i.e., a wire bundle 11, a plurality of connectors 12, 13, 14 and 15 attached to the wire bundle 11, and a plurality of outer cover materials 21, 22 and 23 respectively covering, so as to protect the wire bundle 11, a plurality of outer coverage zones Z1, Z2 and Z3 arranged in a lengthwise direction along a routing path of the wire bundle 11.

Although not shown in detail in the drawings, the wire bundle 11 is configured by a plurality of electric wires including, for example, any of a power supply line, a signal line or a ground line or the like to an electric acuator or sensor or other device mounted on the vehicle. In addition, each electric wire of the wire bundle 11 is configured by, for example, a conductor in a twisted wire form having good electric conductivity and an electrically insulating covering resin which concentrically surrounds the conductor.

The wire bundle 11 has a main line portion 11a in which the group of wires configured by the plurality of electric wires is bundled into one, and a plurality of branch lines 11b, 11c and 11d branching out from the main line portion 11a. The plurality of connectors 12, 13, 14 and 15 are attached to the main line portion 11a and the plurality of branch lines 11b, 11c and 11d.

It is noted that the number of electric wires and the branching form of the wire bundle 11 are not particularly limited. Attachments to the wire bundle 11 are not limited to connectors 12 through 15 and may be terminal metal fittings and terminal splices and the like, and may also be other outer cover materials.

The outer coverage zones Z1, Z2 and Z3 of the wire bundle 11 may be spaced at a constant interval in the lengthwise direction of the main line portion 11a, or set at different separation distances according to branching positions of the plurality of branch lines 11b, 11c and 11d and an allowable bending radius and the like of each portion of the wire bundle 11.

The plurality of outer cover materials 21, 22 and 23 are each formed into a rectangular plate shape from a porous flexible material, as shown in FIG. 1.

Specifically, the plurality of outer cover materials 21, 22 and 23 are each formed into a plate shape by heat molding, using a nonwoven material that is a porous fiber aggregate. That is, the plurality of outer cover materials 21, 22 and 23 are configured as a plurality of plate-shaped bodies configured from porous flexible materials, each having a plate width W in the lengthwise direction of the main line portion 11a of the wire bundle 11, and a respective plate length L greater than the respective plate width W in a radial direction of the main line portion 11a.

In addition, the plurality of plate-shaped outer cover materials 21, 22 and 23 are each configured by first-side nonwoven fabric plates 21a, 22a and 23a, and second-side nonwoven fabric plates 21b, 22b and 23b in the same shape as the first-side nonwoven fabric plates 21a, 22a and 23a.

The first-side nonwoven fabric plates 21a, 22a and 23a and the second-side nonwoven fabric plates 21b, 22b and 23b are each formed into a plate shape by a heat molding mold using nonwoven material, and face each other with the wire bundle 11 therebetween; they are integrally bonded together by being partially joined through heat welding and the like at facing positions spaced from the wire bundle 11.

Here, nonwoven material is a material containing fibers capable of being materials for a nonwoven fabric, and is a porous fiber aggregate in which the fibers are oriented entirely at random and the fibers are joined by fusion, bonding and/or interlacing (entangling), but excludes paper, woven fabric, knitted fabric and the like. However, the porous flexible material referred to in the present invention may include paper, woven fabric, knitted fabric and the like, and may include flexible and lightweight porous materials other than fibers.

The fiber material of the nonwoven material contains a base fiber formed of, for example, PET (polyethylene terephthalate), and a binder fiber in which binders are arranged around the base fiber (see, for example, Japanese Patent Laid-open Publication No. 2011-244614), but is not particularly limited and may be an arbitrary fiber material. Further, joining of the fibers may, in addition to fusion by heat, include chemical bonding and entangling of fibers and the like. It is noted that the binder referred to here has a melting point lower than that of the base fiber, and after being made solvent at a preset temperature or higher, solidifies. Multiple types of binders that become solvent at different temperatures may be contained.

The partial joining of the first-side nonwoven fabric plates 21a, 22a and 23a and the second-side nonwoven fabric plates 21b, 22b and 23b is performed at multiple points spaced at a substantially constant interval along the wire bundle 11 using spot welding and the like, or at at least one portion of an outer peripheral edge portion (but excluding portions where the wire bundle 11 enters and exits the outer cover materials 21, 22 and 23) using heat welding and the like, or a combination thereof. The joining positions at which heat welding and the like are performed are selected, for example, by setting in advance a plurality of candidate positions on the outer cover materials 21, 22 and 23 where joining by spot welding and the like is possible, and then selecting positions from these candidate positions according to the wiring pattern of the wire bundle 11.

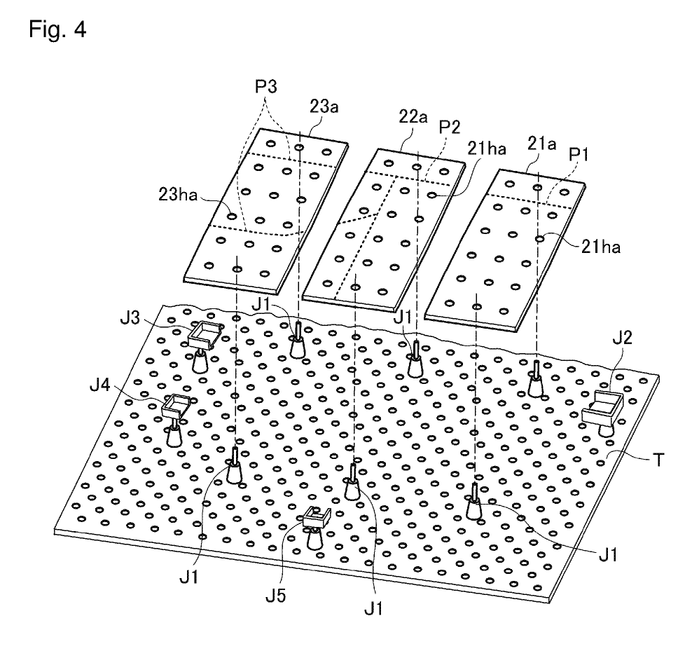

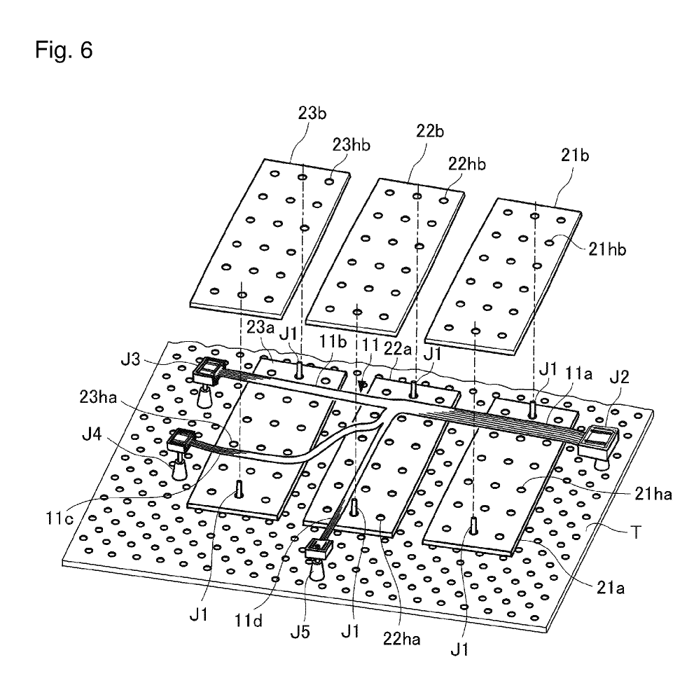

Further, as shown in FIGS. 4 and 6, in the first-side nonwoven fabric plates 21a, 22a and 23a and the second-side nonwoven fabric plates 21b, 22b and 23b, a plurality of through hole portions 21ha, 22ha and 23ha and 21hb, 22hb and 23hb are formed by additional processing after heat molding, for example. The through hole portions penetrate in a plate thickness direction and are formed at an equal pitch so as to be separated from one another by a predetermined interval in a plate width direction and a plate length direction of the outer cover materials 21, 22 and 23.

The plurality of through hole portions 21ha, 22ha and 23ha formed in the first-side nonwoven fabric plates 21a, 22a and 23a have circular opening shapes of the same diameter, for example, and are formed in an opening inner peripheral edge shape such that the first-side nonwoven fabric plates 21a, 22a and 23a can be positioned in predetermined positions using a plurality of support jigs J1 with position pin erected on a wire harness assembly work table T, as described below.

In addition, partial wiring patterns P1, P2 and P3, which correspond to the routing patterns of the wire bundle 11 of the wire harness 10, are drawn on the first-side nonwoven fabric plates 21a, 22a and 23a. Thereby, the wire bundle 11 of the wire harness 10 can be wired along the wiring patterns P1, P2 and P3 on the first-side nonwoven fabric plates 21a, 22a and 23a, which are positioned and held by the plurality of support jigs J1 with position pin on the wire harness assembly work table T.

Although the plurality of through hole portions 21ha, 22ha and 23ha are used to position the first-side nonwoven fabric plates 21a, 22a and 23a, by inserting through the plurality of through hole portions 21ha, 22ha and 23ha columns of some of the work jigs that are erected on the work table T along the routing pattern of the wire bundle 11 of the wire harness 10, it is possible to utilize the plurality of through hole portions 21ha, 22ha and 23ha for assembly work of the wire bundle 11. Further, here, the partial wiring patterns P1, P2 and P3 are drawn on the first-side nonwoven fabric plates 21a, 22a and 23a; however, partial wiring patterns may be drawn on an upper surface of the work table T that is exposed in between and around the first-side nonwoven fabric plates 21a, 22a and 23a, or the number of support jigs J1 with position pin may be increased to serve as wiring guides or dedicated guiding jigs may be provided.

Similar to the plurality of through hole portions 21ha, 22ha and 23ha, the through hole portions 21hb, 22hb and 23hb formed in the second-side nonwoven fabric plates 21b, 22b and 23b also have circular opening shapes of the same diameter, which enables using the support jigs J1 with position pin to position the second-side nonwoven fabric plates 21b, 22b and 23b to overlap on the first-side nonwoven fabric plates 21a, 22a and 23a, and inserting through the through holes the support columns of the plurality of work jigs erected on the work table T.

In addition, when the first-side nonwoven fabric plates 21a, 22a and 23a and the second-side nonwoven fabric plates 21b, 22b and 23b are bonded together by the partial joining described above, the plurality of through hole portions 21ha, 22ha and 23ha and 21hb, 22hb and 23hb form a plurality of through hole portions 21h, 22h and 23h separated from one another by the interval in the plate width direction and the plate length direction of the outer cover materials 21, 22 and 23 (see FIG. 1).

Next, a manufacturing process of the wire harness 10 of the present embodiment, and in particular a covering process by the outer cover materials 21, 22 and 23, will be described.

With respect to the wire bundle 11 of the wire harness 10, end portions of the plurality of electric wires configuring the wire bundle 11 are stripped of their covers, and terminals and the like of connectors 12 through 15 are attached to the end portions. A prescribed uncovered wire harness 10 in a semi-finished product state is produced by loosely bundling the plurality of electric wires with insulating tape and the like, or by bundling them in a state where the electric wires are arranged in parallel as in a flat cable. Here, “loosely bundling” means, even with respect to the main line portion 11a of the wire bundle 11, for example, a bundled state in which a flat cross-section is easily created when the bundle is pressed with a pressing force not more than a predetermined value.

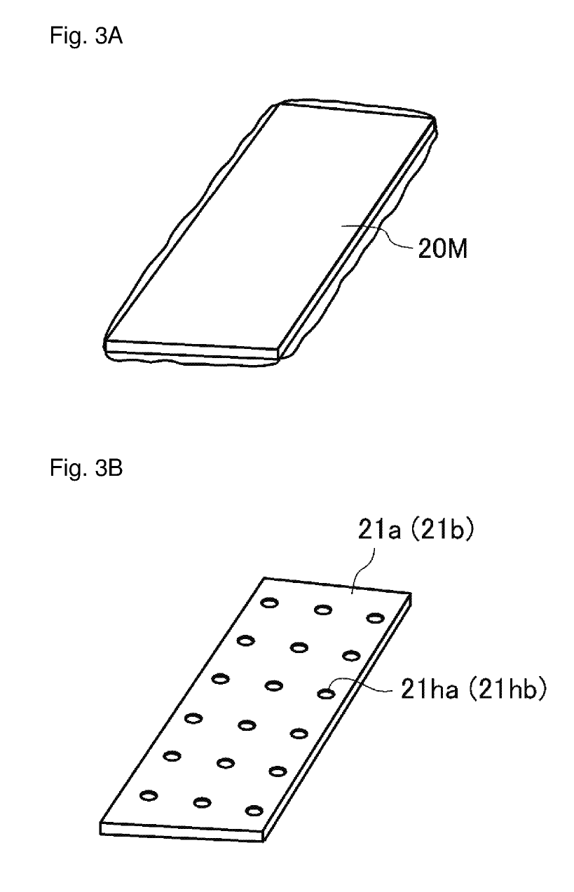

Meanwhile, with respect to the outer cover materials 21, 22 and 23, as shown in FIG. 3A, a plate-shaped nonwoven material 20M is formed by heating and pressing the aforementioned nonwoven material in a heat molding mold so as to cause a portion of the binder to become solvent.

Then, the plate-shaped nonwoven material 20M taken out of the mold is deburred using a so-called Thompson blade, and at the same time, a process of forming a plurality of through holes at an equal pitch is applied thereto as shown in FIG. 3B, thereby producing each of the first-side nonwoven fabric plates 21a, 22a and 23a and the second-side nonwoven fabric plates 21b, 22b and 23b, or as shown in FIG. 3B as an example, the first-side nonwoven fabric plate 21a or the second-side nonwoven fabric plate 21b.

Next, as shown in FIG. 4, the plurality of support jigs J1 with position pin as described above, and a plurality of work jigs J2, J3, J4 and J5 and the like capable of holding the plurality of connectors 12, 13, 14 and 15, are arranged in an erected state on the wire harness assembly work table T.

Next, the first-side nonwoven fabric plates 21a, 22a and 23a are arranged in predetermined areas on the work table T using the plurality of support jigs J1 with positioning pin. The predetermined areas are outer cover material-arranging areas corresponding to the plurality of outer coverage zones Z1, Z2 and Z3 of the wire bundle 11.

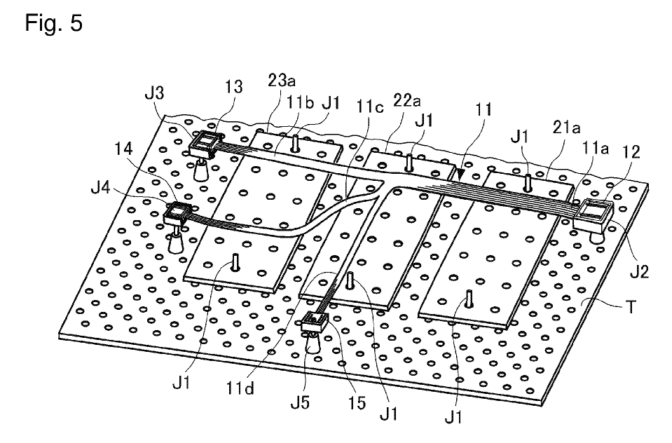

Next, as shown in FIG. 5, the wire bundle 11, which is the uncovered semi-finished wire harness product, is arranged on the plurality of first-side nonwoven fabric plates 21a, 22a and 23a on the work table T so as to lie along the wiring patterns P1, P2 and P3 drawn thereon, and the plurality of connectors 12, 13, 14 and 15 are fitted into and held by the work jigs J2, J3, J4 and J5. At this time, the cross section of the wire bundle 11 is flattened on the first-side nonwoven fabric plates 21a, 22a and 23a.

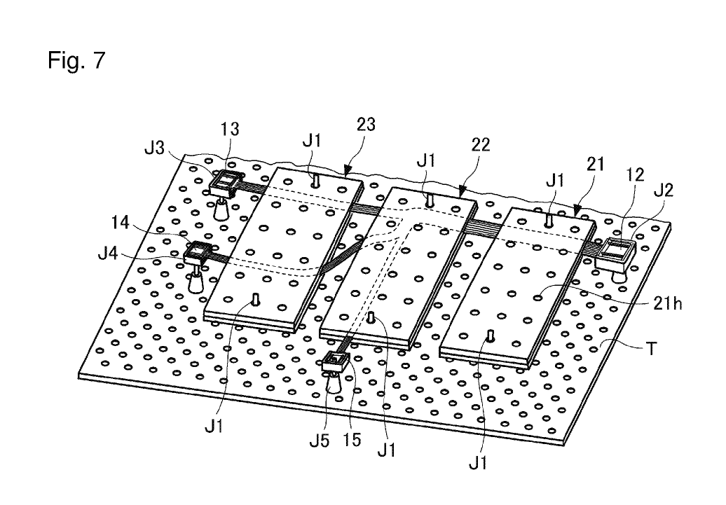

Next, as shown in FIGS. 6 and 7, the second-side nonwoven fabric plates 21b, 22b and 23b of the plurality of outer cover materials 21, 22 and 23 are respectively guided by the plurality of support jigs J1 with positioning pin and arranged so as to overlap on the plurality of first-side nonwoven fabric plates 21a, 22a and 23a and the wire bundle 11, the wire bundle 11 being the uncovered semi-finished wire harness product.

Next, the plurality of first-side nonwoven fabric plates 21a, 22a and 23a and the plurality of second-side nonwoven fabric plates 21b, 22b and 23b in a vertically overlapped state are partially joined with each other at multiple points (but avoiding the wire bundle 11) by spot heat welding and the like, and the nonwoven fabric plates 21a, 22a and 23a and 21b, 22b and 23b are thus integrally bonded together with the wire bundle 11 therebetween, thereby forming the plurality of outer cover materials 21, 22 and 23.

The heat welding work may be performed by arranging on the work table T in advance a receiving surface or jig and the like for performing the partial joining, or the heat welding work may be performed through a gap between the first-side nonwoven fabric plates 21a, 22a and 23a and the second-side nonwoven fabric plates 21b, 22b and 23b and the work table T or through a work hole and the like opened in a work table side.

Next, a covered wire harness 10, in which the wire bundle 11 is covered by the plurality of outer cover materials 21, 22 and 23 as described above, is formed into a packing style product form as shown in FIG. 2 by folding the plurality of outer cover materials 21, 22 and 23 so as to overlap with one another.

When the wire harness 10 in this product form is installed in a body of an automobile (such as in the floor surface of a vehicle cabin and the like, for example), it is returned from the packing style shown in FIG. 2 to an unfolded state close to the required routing pattern as shown in FIG. 1, and then installed.

Next, an operation of the present embodiment will be described.

In the wire harness 10 of the present embodiment having a configuration as described above, the outer coverage zones Z1, Z2 and Z3 of the wire harness 10 can be covered by each of the plate-shaped bodies forming the outer cover materials 21, 22 and 23, and at the same time, the wire harness 10 can be held to run along the arbitrary wiring patterns P1, P2 and P3. Thus, it is possible to commonly use the outer cover materials 21, 22 and 23, irrespective of the routing pattern of the wire harness 10 at the time of installation, and, by using the plurality of outer cover materials 21, 22 and 23, the wire harness 10 can be easily manufactured into the product form where the wire bundle 11 is held in the state close to the required routing pattern.

Furthermore, as shown in FIG. 2, by folding the covered wire harness 10 (in a zig-zag form or in a tubular form) so that the plurality of outer cover materials 21, 22 and 23 overlap one another, the product form thereof can be made compact and simple.

When installing in a body of an automobile, by just unfolding the wire harness from the packing style as shown in FIG. 2 to the state close to the required routing pattern as shown in FIG. 1, it is hardly required to arrange each of the main line portion 11a and the plurality of branch line portions 11b, 11c and 11d of the wire bundle 11 to lie along the body; thereby, the installation workability is greatly improved. Thus, the wire harness 10 has excellent installation workability whereby the number of steps for installing the wire harness in a body side of a vehicle (such as in the floor surface of a vehicle cabin and the like) can be greatly reduced.

In addition, in the present embodiment, since the wire bundle 11 of the wire harness 10 is held at each of the outer coverage zones Z1, Z2 and Z3 by being sandwiched between the first-side nonwoven fabric plates 21a, 22a and 23a and the second-side nonwoven fabric plates 21b, 22b and 23b of the corresponding outer cover materials 21, 22 and 23, by utilizing the protective functions and sound-insulating features and the like of the nonwoven fabric plates, the number of other outer cover materials used for protection and sound insulation and the like can be reduced, thereby reducing manufacturing cost.

In addition, since the cross-section of the wire bundle 11 can be kept flat, thickness can be suppressed as compared to cases where other outer cover materials are attached. Moreover, since there is a high degree of freedom with respect to the wiring pattern of the electric wires inside the outer cover materials 21, 22 and 23, wire length can be reduced by adopting wiring patterns containing many straight line portions, thereby enabling reducing the volume and weight of electric wires used.

Further, in the present embodiment, by utilizing the through hole portions 21h, 22h and 23h of the plurality of plate-shaped outer cover materials 21, 22 and 23, it is possible to position the plurality of first-side nonwoven fabric plates 21a, 22a and 23a and the second-side nonwoven fabric plates 21b, 22b and 23b using the support jigs J1 with positioning pin erected on the wire harness assembly work table T, and insert through the through hole portions support columns of a plurality of arbitrary work jigs erected on the work table T along the routing pattern of the wire harness. Thus, the assembly work of the wire harness 10 is made easier.

Furthermore, the erection positions of the jigs J1 and J2 and the like are set at the pitch unit of the through hole portions 21h, 22h and 23h. Therefore, the same work table T can be made highly versatile in that it can be used to assemble a large variety of wire harnesses, and since there is no need to use a conventional dedicated board with poor recyclability, the manufacturing cost of the wire harness can be reduced in this respect as well.

Additionally, in the present embodiment, the first-side nonwoven fabric plates 21a, 22a and 23a and the second-side nonwoven fabric plates 21b, 22b and 23b are partially heat welded; thus it is possible to achieve stable bonding of the nonwoven fabric plates 21a, 22a and 23a and 21b, 22b and 23b without the use of adhesives or other bonding method.

As described above, according to the present embodiment, it is possible to provide a low-cost wire harness having an outer cover form having good assembly workability and installation workability for installing in vehicles and the like after coverage, and enables reduction of wire length.

In each of the embodiments described above, the first-side nonwoven fabric plates 21a, 22a and 23a and the second-side nonwoven fabric plates 21b, 22b and 23b had the same shape; however, only the one side or only the other side, that is, only the nonwoven fabric plates on one side may be in a rectangular plate shape extending over an entire area of the outer coverage zones Z1, Z2 and Z3, and the nonwoven fabric plates on the other side may have an area large enough to cover the wire bundle 11 and not extending over the entire area of the outer coverage zones Z1, Z2 and Z3. In this case, it is also considered, for example, to have perforations and the like in the nonwoven fabric plates which will become one of the first-side nonwoven fabric plates 21a, 22a and 23a and the second-side nonwoven fabric plates 21b, 22b and 23b, and to use nonwoven fabric plates divided into half-lengths or fold a sheet of the nonwoven fabric so that one of the outer cover materials 21, 22 and 23, the outer cover material 23 for example, is made to be half-length.

In addition, it is also considered to integrate the first-side nonwoven fabric plate and the second-side nonwoven fabric plate forming the same outer cover material; to differentiate thickness of the first-side nonwoven fabric plates from that of the second-side nonwoven fabric plates; and to layer multiple sheets of one of the first-side nonwoven fabric plates and the second-side nonwoven fabric plates in a specific outer coverage zone so that three or more nonwoven fabric plates are layered.

Further, the first-side nonwoven fabric plates 21a, 22a and 23a may be integrated so as to be foldable via a low flexural rigidity portion such as a perforation or a cutting line having a short cutting depth, so that the nonwoven fabric plates can be divided and folded into smaller sizes as needed. Further, guide lines and the like for cutting and folding may be provided in addition to the wiring patterns P1, P2 and P3.

Additionally, in each of the embodiments described above, the outer cover materials 21, 22 and 23 are nonwoven fabric plates that are porous fiber aggregates; however, they are not necessarily limited to nonwoven fabric plates and only need to be lightweight plate-shaped bodies formed of a porous flexible material having flexibility, sound insulation and weather resistance and the like equal to nonwoven fabric plates.

As described above, the present invention enables provision of a low-cost wire harness having an outer cover form having good assembly workability and installation workability for installing in vehicles and the like after coverage, and enables reduction of wire length, and is useful for all wire harnesses equipped with outer cover materials formed of a lightweight and flexible material such as a nonwoven fabric and the like.

### DESCRIPTION OF REFERENCE NUMERALS

10 wire harness

11 wire bundle (group of wires)

11a main line portion

11b, 11c, lid branch lines

12, 13, 14, 15 connectors

20M plate-shaped nonwoven fabric material

21, 22, 23 outer cover materials

21a, 22a, 23a first-side nonwoven fabric plates

21a, 22a, 23a second-side nonwoven fabric plates

21h, 22h, 23h through hole portions

21ha, 22ha, 23ha through hole portions (through portions of the first-side nonwoven fabric plates)

21hb, 22hb, 23hb through hole portions (through hole portions of the second-side nonwoven fabric plates)

J1 support jigs (support jigs with position pin)

J2, J3, J4, J5 work jigs (assembly jigs)

L plate length

P1, P2, P3 wiring patterns

W plate width

Z1, Z2, Z3 outer coverage zones

1. A wire harness comprising:
a plurality of outer covers covering a plurality of outer coverage zones spaced in a lengthwise direction of a main line portion of a wire bundle;
wherein the plurality of outer covers are each formed into a plate shape from a porous flexible material, a the plurality of outer covers being configured as plate-shaped bodies having a plate width in the lengthwise direction of the main line portion and a plate length in a radial direction of the main line portion, the plate length being greater than the plate width.

2. The wire harness according to claim 1, wherein each of the plurality of plate-shaped bodies includes a first-side nonwoven fabric plate and a second-side nonwoven fabric plate facing each other with the wire bundle therebetween and being partially joined.

3. The wire harness according to claim 1, wherein a plurality of through hole portions penetrating in a plate thickness direction are formed at an equal pitch in each of the plurality of plate-shaped bodies.

4. The wire harness according to claim 2, wherein the first-side nonwoven fabric plate and the second-side nonwoven fabric plate are partially heat welded.

5. The wire harness according to claim 2, wherein a plurality of through hole portions penetrating in a plate thickness direction are formed at an equal pitch in each of the plurality of plate-shaped bodies.

6. The wire harness according to claim 4, wherein a plurality of through hole portions penetrating in a plate thickness direction are formed at an equal pitch in each of the plurality of plate-shaped bodies.
